(19) United States
(12) Patent Application Publication
(10) Pub. No.: US 2026/0216973 A1
(43) Pub. Date: Jul. 30, 2026

(54) METHOD FOR PRODUCING PARTS MADE OF COMPOSITE MATERIAL HAVING AN ORGANIC MATRIX

(71) Applicant: SAFRAN, PARIS (FR)

(72) Inventors: Christophe RAVEY, MOISSY-CRAMAYEL (FR); Romain VENAT, MOISSY-CRAMAYEL (FR); Romain PICON, MOISSY-CRAMAYEL (FR); Romain BUI, MOISSY-CRAMAYEL (FR)

(21) Appl. No.: 19/152,288

(22) PCT Filed: Jan. 17, 2024
(86) PCT No.: PCT/FR2024/050065

§ 371 Date: Jul. 30, 2025

(30) Foreign Application Priority Data
Feb. 1, 2023 (FR) FR2300915

(51) Int. Cl. B29C 70/48; B29C 70/00; B29C 70/24; B29C 70/44; B29K 63/00; B29K 105/08

(52) U.S. Cl. CPC B29C 70/48; B29C 70/003; B29C 70/24; B29C 70/443; B29K 2063/00; B29K 2105/0845; B29K 2995/0012; B29K 2995/007

(57) ABSTRACT

A method for producing a part made of composite material having an organic matrix, includes arranging a fibrous preform in a mould including an impregnation chamber by resting a first face of the fibrous preform on a support surface of the impregnation chamber that is closed by a flexible membrane, the flexible membrane separating the impregnation chamber from a compaction chamber; injecting a compaction fluid into the compaction chamber to apply a compaction pressure to the flexible membrane; injecting a resin into the impregnation chamber from a lateral face to the first face of the fibrous preform in a direction parallel to the surface of the membrane, so that the resin impregnates the fibrous preform and polymerises to form an organic matrix within the fibrous preform, the compaction pressure being maintained on the flexible membrane before and during the injection and polymerisation of the resin.

### TECHNICAL FIELD

The present invention relates to the general field of producing parts made of composite material having an organic matrix, in particular fan casing parts.

### PRIOR ART

These parts are usually made from a fibrous preform impregnated with a resin which, when polymerizing, forms an organic matrix within the fibrous preform.

The organic matrix can be formed by an RTM (Resin Transfer Molding) method. The preform is placed in a tool, such as a closed mold, into which a resin is injected within the preform, through one or more injection ports located facing a lateral face of the preform. During the polymerization of the resin, a compaction pressure is applied through the injection ports. However, this pressure is not applied uniformly over the entire preform, which results in pressure losses between the resin injection ports and the rest of the preform.

To limit pressure loss, the organic matrix can be formed using the C-RTM (Compression Resin Transfer Molding) method. The resin is injected over the preform and the compaction pressure is applied to the entire top of the preform as the resin polymerizes. However, this method is not applicable to axisymmetric parts, as it is impossible to create a concentric rigid circular tool to apply the compaction pressure.

In order to overcome these two problems, the organic matrix can still be formed by the Polyflex method described in particular in document US2016297153. The Polyflex method consists of applying compaction pressure to the top of the preform using a flexible membrane located on top of the preform. A compaction fluid present between the flexible membrane and the tool allows to press the membrane onto the preform and apply this compaction pressure so that the resin penetrates throughout the preform, however, when the compaction fluid exceeds the resin penetration front, a filling defect is created within the preform because the circulation of the resin is blocked. The resulting parts are partially dry, non-compliant and therefore rejected.

It is therefore desirable to have a method for producing parts made of composite material having an organic matrix that guarantees the filling of the preform with the resin and its quality as well as the good polymerization of the resin.

### DISCLOSURE OF THE INVENTION

The invention relates to a method for producing a part made of composite material having an organic matrix comprising the following steps:
arranging a fibrous preform of the part to be produced in a mold comprising an impregnation chamber by resting a first face of the fibrous preform on a support surface of the impregnation chamber, the impregnation chamber being closed by a flexible membrane placed facing a second face of the fibrous preform, said flexible membrane separating the impregnation chamber from a compaction chamber,
injecting a compaction fluid into the compaction chamber so as to apply a compaction pressure to the flexible membrane, and
injecting a resin into the impregnation chamber from a lateral face to the first face of the fibrous preform in a direction parallel to the surface of the membrane so that the resin impregnates the fibrous preform and polymerizes to form an organic matrix within the fibrous preform, the compaction pressure being maintained on the flexible membrane before and during the injection and polymerization of the resin.

By applying the compaction pressure before injecting resin onto the flexible membrane, this allows the membrane to adapt to the geometry of the fibrous preform to apply uniform pressure thereto. It is therefore possible to produce axisymmetric casing-type parts with the method of the invention.

In addition, by maintaining a compaction pressure during injection and polymerization of the resin into the fibrous preform, homogeneous filling of the preform can be ensured without the circulation of the resin being blocked by the membrane and the compaction fluid while maintaining a uniform pressure over the entire fibrous preform.

Thus, thanks to the method of the invention, the material health of the produced parts is improved.

According to a particular characteristic of the invention, the compaction pressure is variable during the injection and/or polymerization of the resin. The compaction pressure can vary between 1 bar and 30 bars.

For example, the compaction pressure can be increased during resin polymerization. This improves material health, particularly at the resin, by reducing the risk of chemical porosity appearing.

According to another particular characteristic of the invention, the compaction fluid is an oil.

According to another particular characteristic of the invention, the method also comprises the removal of the fibrous preform from the mold after the polymerization of the resin.

According to another particular characteristic of the invention, the resin is a thermosetting epoxy resin.

According to another particular characteristic of the invention, the flexible membrane has a coefficient of thermal expansion comprised between 150 μm/m-° C. and 300 μm/m-° C. and a Shore A hardness comprised between 50 and 80.

This allows the membrane to adapt to the geometry of the preform without deforming when compaction pressure is applied.

According to another particular characteristic of the invention, the fibrous preform is produced by three-dimensional weaving of fibers.

Thus, as the fibrous preform is intended to form the fiber reinforcement of the part to be produced, the final part will have very good mechanical properties and a low risk of delamination.

### BRIEF DESCRIPTION OF THE DRAWINGS

Other characteristics and advantages of the present invention will emerge from the description given below, with reference to the appended drawings which illustrate exemplary embodiments thereof which are not limiting in nature.

FIG. 1 schematically shows a production method according to one embodiment of the invention.

FIG. 2A schematically and partially shows an example mold allowing to implement the production method of the invention.

FIG. 2B schematically and partially shows the mold of FIG. 2A during the injection of the resin into the impregnation chamber.

### DESCRIPTION OF THE EMBODIMENTS

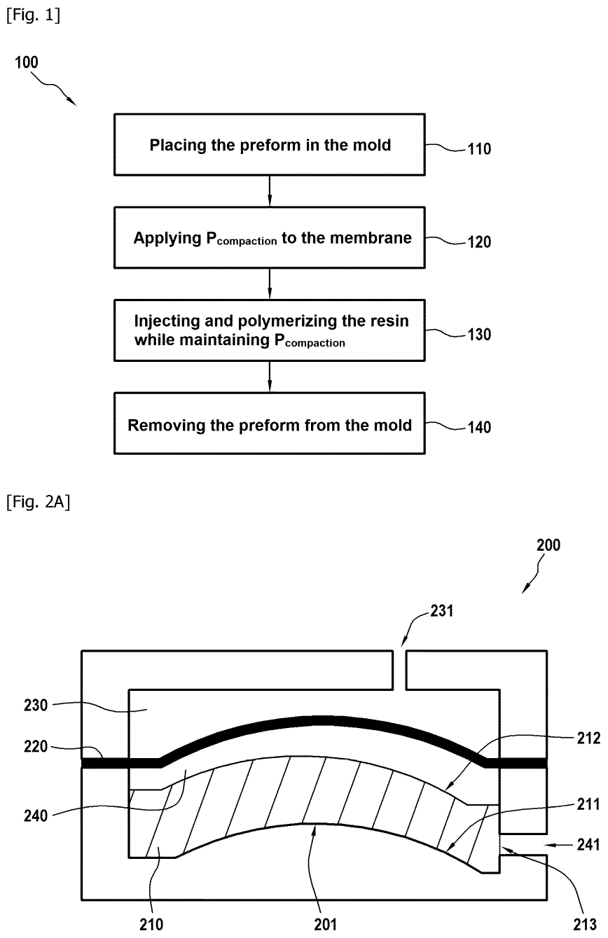

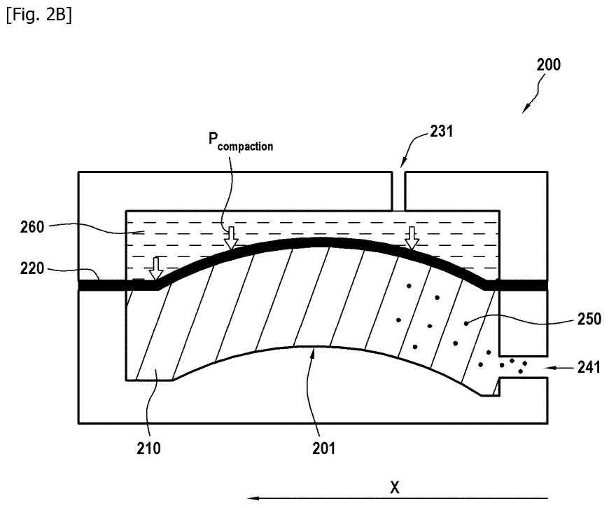

The invention is described with reference to FIGS. 1, 2A and 2B, FIG. 1 schematically showing a method 100 for producing a part made of composite material having an organic matrix according to an embodiment of the invention and FIGS. 2A and 2B showing a mold allowing to implement the method 100.

The method 100 first comprises arranging 110 a fibrous preform 210 of the part to be produced in a mold 200. The mold 200 comprises an impregnation chamber 240 and a compaction chamber 230 separated by a flexible membrane 220.

The fibrous preform 210 is intended to form the fiber reinforcement of the composite material part to be produced. It is considered here as the fiber structure of the composite material part to be produced, obtained by any technique or combination of textile construction, arrangement and deformation techniques to arrange it in the mold 200.

The preform 210 can thus be produced at least in part by stacking layers or folds obtained by two-dimensional (2D) weaving. It can also be produced directly in a single piece by three-dimensional weaving. “Two-dimensional weaving” means here a conventional weaving method by which each weft thread passes from one side to the other of threads of a single warp layer or vice versa. “Three-dimensional weaving” means here a weaving by which warp threads pass through several layers of weft threads, or weft threads pass through several layers of warp threads.

The preform 210 can also be made at least in part by sheets of unidirectional (UD) fibers, which can be obtained by laying ribbons or by automatic placement of the fibers (AFP for “Automated Fiber Placement”), or by filament winding.

The preform 210 may be made from ceramic fibers or carbon fibers, or from a mixture of the two. In particular, the preform 210 may be made from fibers made of the following materials: alumina, mullite, silica, an aluminosilicate, a borosilicate, silicon carbide, carbon, or a mixture of several of these materials. The preform 210 may comprise any type of glass fibers.

The preform 210 comprises a first face 211 and a second face 212 facing the first face 211. The preform 210 is placed in the mold 200 by resting its first face 211 on a support surface 201 of the impregnation chamber 240. The flexible membrane 220 is facing the second face 212 of the preform 210, and in the impregnation chamber 240, it is facing the support surface 201 of the impregnation chamber 240.

Then, a compaction fluid 260 is injected into the compaction chamber 230 so as to apply a compaction pressure P_{compaction} to the flexible membrane 220 (step 120 of FIG. 1). The injection of the compaction fluid 260 can be done through an inlet port 231 of the mold 200 located facing the flexible membrane 220 and opening into the compaction chamber 230. The compaction pressure P_{compaction} thus applied allows to deform the membrane 220 so that it becomes pressed against the fibrous preform 210.

Next, a resin 250 is injected into the compaction chamber 240 (step 130) from a lateral face 213 to the first face 211 of the fibrous preform 210 in a direction X parallel to the surface of the membrane 220 so that the resin 250 impregnates the fibrous preform 210 and polymerizes to form an organic matrix. The injection 130 of the resin 250 can be done via an inlet port 241 located facing the lateral face 213 of the preform 210. During this step 130 of injection and polymerization of the resin 250, the compaction pressure P_{compaction} is maintained on the flexible membrane 220.

Finally, the method 100 may comprise the removal 140 of the fibrous preform 210 from the mold after the polymerization of the resin 220.

The compaction pressure P_{compaction} can be variable during the injection and polymerization of the resin 220. It varies for example between 1 bar and 30 bars.

The compaction fluid 260 is for example an oil.

The resin 220 is for example a thermosetting epoxy resin.

The flexible membrane 220 has a coefficient of thermal expansion comprised between 150 μm/m-° C. and 300 μm/m-° C. and a Shore A hardness comprised between 50 and 80. It is for example made of silicone, or an elastomer-type material. It can be reinforced with glass or polyester fibers. These examples of characteristics allow the flexible membrane 220 to be sufficiently flexible to adapt to the geometry of the preform 210 while remaining minimally rigid to withstand the compaction pressure P_{compaction} applied by the compaction fluid 260.

The expression “comprised between . . . and . . . ” must be understood as including the limits.

1. A method for producing a part made of composite material having an organic matrix, comprising:
arranging a fibrous preform of the part to be produced in a mold comprising an impregnation chamber by resting a first face of the fibrous preform on a support surface of the impregnation chamber, the impregnation chamber being closed by a flexible membrane placed facing a second face of the fibrous preform, said flexible membrane separating the impregnation chamber from a compaction chamber,
injecting a compaction fluid into the compaction chamber so as to apply a compaction pressure to the flexible membrane,
injecting a resin into the impregnation chamber from a lateral face to the first face of the fibrous preform in a direction parallel to the surface of the membrane so that the resin impregnates the fibrous preform and polymerizes to form an organic matrix within the fibrous preform, the compaction pressure being maintained on the flexible membrane before and during the injection, wherein the compaction pressure is further increased during the polymerization of the resin.

2. The production method according to claim 1, wherein the compaction pressure is variable during the injection and polymerization of the resin.

3. The production method according to claim 1, wherein the compaction fluid is an oil.

4. The production method according to claim 1, further comprising removing the fibrous preform from the mold after the polymerization of the resin.

5. The production method according to claim 1, wherein the resin is a thermosetting epoxy resin.

6. The production method according to claim 1, wherein the flexible membrane has a coefficient of thermal expansion comprised between 150 μm/m-° C. and 300 μm/m-° C. and a Shore A hardness comprised between 50 and 80.

7. The production method according to claim 1, wherein the fibrous preform is produced by three-dimensional weaving of fibers.
